(19) United States
(12) Patent Application Publication
(10) Pub. No.: US 2009/0182881 A1
(43) Pub. Date: Jul. 16, 2009

(54) NETWORK COMMUNICATION DEVICE AND INTERNET PROTOCOL SESSION DISTRIBUTING METHOD

(75) Inventors: CHI-HSIEN HUANG, Tu-Cheng (TW); MING LIU, Shenzhen City (CN); YONG ZENG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/185,104

(22) Filed: Aug. 3, 2008

(30) Foreign Application Priority Data
Jan. 14, 2008 (CN) 200810300088.3

(51) Int. Cl. G06F 15/16

(52) U.S. Cl. 709/227

(57) ABSTRACT

A network communication device establishes a communication connection between a terminal device and an electronic communication network. The network communication device includes a database module, a transceiving module, a determining module, and a connection determining module. The database module stores a plurality of internet protocol (IP) sessions, a maximum number of connections provided for the plurality of IP sessions, and an allowable number of connections provided for the plurality of IP sessions. The transceiving module receives an IP session request sent by the terminal device. The determining module determines an IP session type corresponding to the IP session request. The connection determining module determines if a current connection number of the IP session type corresponding to the IP session request exceeds the maximum number of connections from the plurality of IP sessions and determining whether to establish an IP session connection responding to the IP session request.

### BACKGROUND

1. Field of the Invention

The present disclosure generally relates to network communication devices and, more particularly to a network communication device employing an internet protocol (IP) session distributing method.

2. Description of Related Art

A router provides a plurality of internet protocol (IP) session connections for all kinds of IP session requests. The router cannot distribute connections to a new IP session requests if all allowable connections have already been occupied by current IP sessions. However, if a new IP session request has a higher priority, then the router may release the connection of the current IP session and distribute the released connection to the new IP session request. Consequentially, the IP session in processing would be interrupted.

Therefore, a heretofore unaddressed need exists in the industry to overcome the aforementioned deficiencies and inadequacies.

### SUMMARY

A network communication device establishes a communication connection between a terminal device and an electronic communication network. The network communication device includes a database module, a transceiving module, a determining module, and a connection determining module. The database module stores a plurality of internet protocol (IP) sessions, a maximum number of connections provided for the plurality of IP sessions, and an allowable number of connections provided for the plurality of IP sessions. The transceiving module receives an IP session request sent by the terminal device. The determining module determines an IP session type corresponding to the IP session request. The connection determining module determines if a current connection number of the IP session type corresponding to the IP session request exceeds the maximum number of connections from the plurality of IP sessions and determining whether to establish an IP session connection responding to the IP session request.

Other objectives, advantages and novel features of the present disclosure will be drawn from the following detailed description of preferred embodiments of the present disclosure with the attached drawings, in which:

### BRIEF DESCRIPTION OF THE DRAWINGS

FIG. 1 is a schematic diagram showing functional modules of a network communication device in accordance with an embodiment of the present disclosure; and

FIG. 2 is a flowchart of an internet protocol (IP) session distributing method in accordance with another embodiment of the present disclosure.

### DETAILED DESCRIPTION OF CERTAIN INVENTIVE EMBODIMENTS

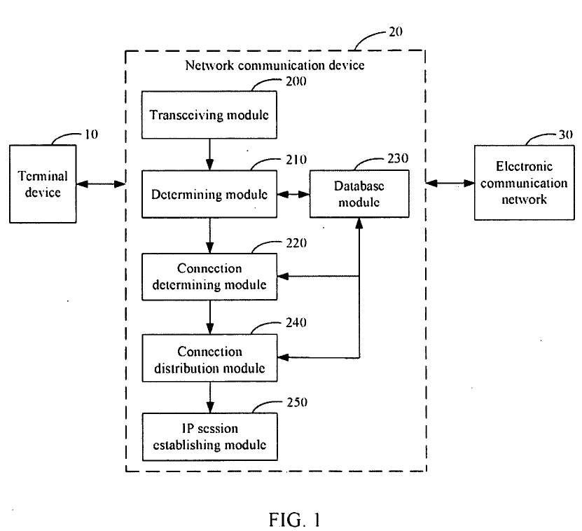

FIG. 1 is a schematic diagram showing functional modules of a network communication device 20 in accordance with an embodiment of the present disclosure.

In the embodiment of FIG. 1, the network communication device 20 communicates with a terminal device 10 and an electronic communication network 30. The network communication device 20 is configured for receiving an internet protocol (IP) session request sent by the terminal device 10, and for distributing an IP session connection to the terminal device 10 in order to establish an IP session between the terminal device 10 and the electronic communication network 30. Depending on the embodiment, the network communication device 20 may be a router, a media gateway, or another device that can process transmission control protocol/internet protocol (TCP/IP). In one embodiment, the terminal device 10 may be a computerized device, such as a computer, a server, or a notebook computer. The terminal device 10 includes one or more application programs that can send the IP session request to the network communication device 20.

In one embodiment, the network communication device 20 includes a transceiving module 200, a determining module 210, a connection determining module 220, a database module 230, a connection distribution module 240, and an IP session establishing module 250.

The database module 230 stores a plurality of IP sessions, a maximum number of connections provided for the plurality of IP sessions, an allowable number of connections provided for the plurality of IP sessions, and a current number of all IP sessions processing in the network communication device 20. The IP session can be distinguished with different protocols, such as the hyper text transfer protocol (HTTP) and the file transfer protocol (FTP). The IP session can also be distinguished by a port number of the IP session request. For example, a FTP session might be distinguished by a signal received/sent from a port 21, and a HTTP session might be distinguished by a signal sent/received from a port 80. In one embodiment, at least one IP session may be classified as either one of two types: a usual IP session and an unusual IP session. The usual IP session represents those IP sessions configured with port numbers ranging from 1 to 1024. For example, the port number of the hypertext transfer protocol (HTTP) session is 80, the port number of the file transfer protocol (FTP) session is 21, and the port number of the simple mail transfer protocol (SMTP) session is 25, all of which are classified as usual IP sessions. The unusual IP session represents those IP sessions configured with port numbers ranging from 1025 to 65535, such as an application named Bittorrent (BT). In one embodiment, the maximum number of connections provided for the usual IP session equals the allowable number of connections provided for all IP sessions by the network communication device 20. In one embodiment, the maximum number of connections provided for the unusual IP session is 80 percent of the allowable number of connections provided for all IP sessions by the network communication device 20. For example, if the allowable number of connections provided for all IP sessions by the network communication device 20 is 1000, then the maximum number of connections provided for usual IP sessions is 1000, and the maximum number of connections provided for unusual IP sessions is 800. The current number of all IP sessions is the sum of all usual IP sessions and unusual IP sessions.

The transceiving module 200 communicates with the terminal device 10 by initially receiving the IP session request sent by the terminal device 10, which is then sent to the determining module 210.

The determining module 210 communicates with the transceiving module 200 and the database module 230, so as to establish an IP session corresponding to the IP session request sent by the transceiving module 200. In one embodiment, the determining module 210 determines an IP session type corresponding to the IP session request by comparing a port number of the IP session request and a port number of the IP session stored in the database module 230. The IP session type comprises the usual IP session representing those IP sessions configured with port numbers ranging from 1 to 1024, and the unusual IP session representing those IP sessions configured with port numbers ranging from 1025 to 65535.

In one embodiment, the determining module 210 sends the IP session request and the IP session type corresponding to the IP session request to the connection determining module 220.

The connection determining module 220 communicates with the determining module 210 and the database module 230. The connection determining module 220 receives the IP session request and IP session type corresponding to the IP session request to determine if the connection number of the IP session corresponding to the IP session request exceeds the maximum number of connections corresponding to the IP session provided by the network communication device 20. The connection determining module 220 determines the current connection number of the IP session request stored in the database module 230 and determines if the request exceeds the maximum number of connections provided for the network communication device 20. In one embodiment, if the IP session is a usual IP session, then the maximum number of connections provided by the network communication device 20 may be 1000. If the IP session is an unusual IP session, then the maximum number of connections provided by the network communication device 20 may be 800.

The connection determining module 220 rejects the IP session request when the connection determining module 220 determines that the IP session corresponding to the IP session request processing in the network communication device 20 exceeds the maximum number of connections provided for the IP session corresponding to the IP session request by the network communication device 20.

The connection determining module 220 determines if the current connection number of all IP sessions exceeds the allowable number of connections provided by the network communication device 20 in the event that the number of connections of the IP session corresponding to the IP session request does not exceed the maximum number of connections can be provided by the network communication device 20. In one embodiment, the connection determining module 220 determines if the current connection number of all IP sessions exceeds the allowable number of connections provided by the network communication device 20 by comparing the current IP session and the allowable IP session connection number stored in the database module 230. The connection determining module 220 rejects the IP session request when the current connection number of the IP session corresponding to the IP session request exceeds the allowable number of connections can be provided by the network communication device 20.

The connection determining module 220 sends the IP session request and the IP session type to the connection distribution module 240 if the connection number of the IP session corresponding to the IP session request does not exceed the maximum number of connections can be provided by the network communication device 20.

The connection distribution module 240 communicates with the connection determining module 220 and the database module 230 receives the IP session request and the IP session type sent by the connection determining module 220, and distributes a free connection number to the IP session request. The IP session establishing module 250 establishes the IP session connection distributed by the connection distribution module 240 between the terminal device 10 and the electronic communication network 30. The connection distribution module 240 distributes the free connection number to the terminal device 10. The connection distribution module 240 determines the free connection number by querying the connection number of the IP session corresponding to the IP session request stored in the database module 230.

In one embodiment, the IP session establishing module 250 communicates with the connection distribution module 240 and the terminal device 10. The electronic communication network 30 receives the connection number sent by the connection determining module 220 and establishes the IP session connection over the IP session connection number, which is distributed by the connection distribution module 240 between the terminal device 10 and the electronic communication network 30.

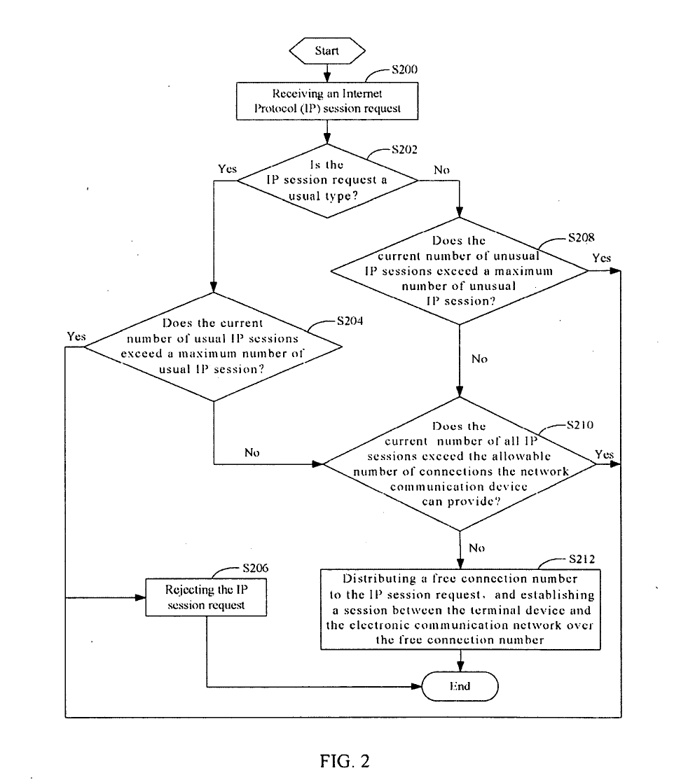

FIG. 2 is a flowchart of an IP session distributing method in accordance with an embodiment of the present disclosure. In the embodiment of FIG. 2, the network communication device 20 connects to the terminal device 10. The network communication device 20 distributes an IP session connection number to the terminal device 10 to establish an IP session between the terminal device 10 and the electronic communication network 30 when the network communication device 20 receives an IP session request from the terminal device 10. In one embodiment, the network communication device 20 may be a router and the terminal device 10 may be a computer.

In block S200, the transceiving module 200 receives an IP session request sent by the terminal device 10, and sends the IP session request to the determining module 210.

In block S202, the determining module 210 determines an IP session type corresponding to the IP session request. In one embodiment, the determining module 210 determines the IP session type corresponding to the IP session request by comparing a port number of the IP session request and a port number of the IP session stored in the database module 230.

The usual IP session indicates those IP sessions configured with port numbers ranging from 1 to 1024. If the determining module 210 determines the IP session request is a usual IP session, block S204 is executed. In block S204, the connection determining module 220 receives the IP session request and the IP session of the IP session request sent by the determining module 210. The connection determining module 220 determines if the number of usual IP sessions processing in the network communication device 20 exceeds the maximum number of connections of usual IP sessions provided by the network communication device 20. In one embodiment, the maximum number of usual IP sessions provided by the network communication device 20 is 1000. If the connection determining module 220 determines that the number of usual IP session exceeds 1000, block S206 is executed. In block S206, the connection determining module 220 rejects the IP session request.

If the connection determining module 220 determines that the connection number of usual IP sessions does not exceed the allowable number of usual IP sessions provided by the network communication device 20, block S210 is executed.

Unusual IP sessions indicates those IP sessions configured with port numbers ranging from 1025 to 65535. If the determining module 210 determines the IP session request is an unusual IP session, block S208 is executed. In block S208, the connection determining module 220 receives the IP session request and the IP session of the IP session request from the determining module 210. The connection determining module 220 determines if the connection number of unusual IP sessions processing in the network communication device 20 exceeds the allowable connection number of unusual IP session provided by the network communication device 20. In one embodiment, the allowable number of unusual IP session provided by the network communication device 20 is 800. If the connection determining module 220 determines that the number of unusual IP sessions exceeds 800, block S206 is executed.

In block S210, the connection determining module 220 determines if the current connection number of the IP session exceeds the maximum number of connections provided by the network communication device 20. In one embodiment, the connection determining module 220 determines if the current IP session connection number exceeds the maximum number of connections provided by the network communication device 20 by comparing the current IP session connection number stored in the database module 230 and the maximum IP session connections provided by the network communication device 20. If the current connection number of the IP session exceeds the maximum number of connections provided by the network communication device 20, block S206 is executed.

The connection determining module 220 sends the IP session request and the IP session of the IP session request to the connection distribution module 240. If the current connection number of the IP session does not exceed the maximum number of connections provided by the network communication device 20, block S212 is executed.

In block S212, the connection distribution module 240 distributes the connection number to the IP session request, and the IP session establishing module 250 establishes the IP session between the terminal device 10 and the electronic communication network 30. In one embodiment, the connection distribution module 240 distributes a free connection number to the IP session request. The connection distribution module 240 determines if there are any free connection numbers by querying the connection number of the IP session corresponding to the IP session request and the maximum IP session connections stored in the database module 230.

The network communication device 20 and the IP session distributing method limit the number of unusual IP sessions to avoid the unusual IP sessions from occupying too many connections, thereby ensuring adequate space for usual IP sessions. Accordingly, the usual IP sessions flowing through the network communication device 20 have an increased reliability.

The description of the present disclosure has been presented for purposes of illustration and description, and is not intended to be exhaustive or limited to the present disclosure in the form disclosed. Many modifications and variations will be apparent to those of ordinary skill in the art. Various inventive embodiments were chosen and described in order to best explain the principles of the present disclosure, the practical application, and to enable others of ordinary skill in the art to understand the present disclosure for various embodiments with various modifications as are suited to the particular use contemplated.

What is claimed is:

1. A network communication device for establishing a communication connection between a terminal device and an electronic communication network, the network communication device comprising:
a database module configured for storing a plurality of internet protocol (IP) sessions, a maximum number of connections provided for the plurality of IP sessions, and an allowable number of connections provided for the plurality of IP sessions;
a transceiving module configured for receiving an IP session request sent by the terminal device, wherein the IP session request is from the plurality of IP sessions;
a determining module configured for determining an IP session type corresponding to the IP session request; and
a connection determining module configured for determining if a current connection number of the IP session type corresponding to the IP session request exceeds the maximum number of connections from the plurality of IP sessions and determining whether to establish an IP session connection responding to the IP session request.

2. The network communication device as claimed in claim 1, wherein the connection determining module rejects the IP session request upon the condition that the current connection number of the IP session corresponding to the IP session request exceeds the maximum number of connections.

3. The network communication device as claimed in claim 1, wherein the connection determining module determines if the current connection number of all IP sessions exceeds the allowable number of connections upon the condition that the current number of connections of the IP session corresponding to the IP session request does not exceed the maximum number of connections of the IP session.

4. The network communication device as claimed in claim 3, further comprising:
a connection distribution module configured for distributing an IP session connection to the IP session request according to the IP session corresponding to the IP session request upon the condition that the current connection number of all IP sessions does not exceed the allowable number of connections; and
an IP session establishing module configured for establishing the IP session connection over the IP session number distributed by the connection distribution module between the terminal device and the electronic communication network.

5. The network communication device as claimed in claim 4, wherein the IP session includes a usual IP session and an unusual IP session.

6. The network communication device as claimed in claim 5, wherein the usual IP session indicates those IP sessions configured with port numbers ranging from 1 to 1024, and the unusual IP session indicates those IP sessions configured with port numbers ranging from 1025 to 65535.

7. The network communication device as claimed in claim 5, wherein the current connection number of the IP session type comprises a number of usual IP sessions and a number of unusual IP sessions.

8. The network communication device as claimed in claim 6, wherein the determining module determines the IP session type corresponding to the IP session request by comparing the port number of the IP session request and that of the IP session stored in the database module.

9. An internet protocol (IP) session distributing method for establishing a communication connection between a terminal device and an electronic communication network using a network communication device, the IP session distributing method comprising:
receiving an IP session request sent by the terminal device;
determining an IP session type corresponding to the IP session request;
determining if a current number of the IP sessions corresponding to the IP session request exceeds a maximum number of connections provided for the IP session corresponding to the IP session request;
determining if a current number of all IP sessions processing in the network communication device exceeds an allowable number of connections upon the condition that the current number of the IP sessions corresponding to the IP session request does not exceed the maximum number of connections;
distributing an IP session number of connections according to the IP session request upon the condition that the current number of all IP sessions does not exceed the allowable number of connections; and
rejecting the IP session request when the current number of all IP sessions exceeds the allowable number of connections.

10. The IP session distributing method as claimed in claim 9, wherein the block of determining if the current number of the IP sessions corresponding to the IP session request exceeds the maximum number of connections further comprises:
querying the current number of the IP sessions corresponding to the IP session request stored in the database module according to the IP session corresponding to the IP session request; and
comparing the current number of the IP sessions corresponding to the IP session request and the maximum number of connections of the IP session corresponding to the IP session request.

11. The IP session distributing method as claimed in claim 9, wherein the block of distributing the IP session connection number according to the IP session request comprises:
querying the current connection number and the maximum number of connections of the IP session corresponding to the IP session request stored in the database module; and
distributing a free connection number to the IP session request.

12. The IP session distributing method as claimed in claim 9, wherein the IP session comprises a number of usual IP sessions and a number of unusual IP sessions.

13. The IP session distributing method as claimed in claim 12, wherein the usual IP session indicates those IP sessions configured with port numbers ranging from 1 to 1024, and the unusual IP session indicates those IP sessions configured with port numbers ranging from 1025 to 65535.

14. The IP session distributing method as claimed in claim 12, wherein the current connection number of all IP sessions comprises the number of usual IP sessions and unusual IP session.

15. The IP session distributing method as claimed in claim 12, wherein the block of determining the IP session corresponding to the IP session request comprises:
comparing the port number of the IP session request and all of the port numbers of the IP session stored in the database module.

16. The IP session distributing method as claimed in claim 9, further comprising: rejecting the IP session request upon the condition that the current connection number of the IP session corresponding to the IP session request exceeds the maximum number of connections.
